(19) United States
(12) Patent Application Publication
(10) Pub. No.: US 2021/0162723 A1
(43) Pub. Date: Jun. 3, 2021

(54) LID MATERIAL FOR BLISTER PACKS

(71) Applicant: Kyodo Printing Co., Ltd., Tokyo (JP)

(72) Inventors: Atsushi YASUDA, Tokyo (JP); Kenta SUZUKI, Tokyo (JP)

(73) Assignee: Kyodo Printing Co., Ltd., Tokyo (JP)

(21) Appl. No.: 15/734,402

(22) PCT Filed: May 27, 2019
(86) PCT No.: PCT/JP2019/020956

§ 371 Date: Dec. 2, 2020

(30) Foreign Application Priority Data
Jun. 14, 2018 (JP) 2018-113955

(51) Int. Cl. B32B 27/08; B65D 75/36; B32B 7/06; B32B 27/32; B32B 27/30

(52) U.S. Cl. CPC B32B 27/08; B65D 75/366; B32B 7/06; B32B 2439/80; B32B 27/304; B32B 2307/726; B32B 2270/00; B32B 27/32

(57) ABSTRACT

A lid for a blister pack is provided with, in order, a substrate layer, a polyolefin-containing layer, and a readily-peelable layer. The readily-peelable layer contains acrylic-modified polyolefin and maleic acid-modified polyolefin.

### FIELD

The present invention relates to a cover (lid) material for blister packs. Further, the present invention relates to a blister packs, and a combination of the cover material for blister packs and a blister package.

### BACKGROUND

Conventionally, blister packs have been used as packaging containers for solid formulations such as tablets and for capsules containing medicines. The blister pack can be formed by forming a recess called a pocket in a blister package sheet composed of a resin sheet or the like to form a blister package, putting the contents in the pocket, and bonding a cover material (cover member) by heat sealing or the like.

In the state of a formulation or the like being accommodated inside the pocket of the blister package, a cover member is heat-sealed to a skirt portion extending around the pocket to provide a contents-containing blister pack in which the formulation or the like is enclosed. When the blister package and/or cover material used for packaging is transparent, the formulation enclosed thereinside can be easily seen. The means mainly employed for taking out the contents from the blister pack is to deform the pocket of the blister package by pressing it from the outside to the cover material side, break the cover material with the content, and take out the contents (push-through).

In addition, in recent years, there has been proposed a technique of forming a resin-based layer on a cover material for blister package, as disclosed in, for example, Patent Literature 1.

### CITATION LIST

### Patent Literature

[PTL 1] JP 2012-520802 A

### SUMMARY

### Technical Problem

In recent years, there have been various forms of contents enclosed in a blister pack, such as tablets of soft gel-like substances or orally disintegrating tablets, and in some cases, the contents cannot be taken out by a conventional push-through means.

Furthermore, when a cover material having a resin-based layer is pushed through as in a conventional manner, it is necessary to break the layer, but such a breaking may not be preferable depending on the aspect of the cover material.

Accordingly, there is a need to provide a cover material for blister pack easily openable without breaking the cover material.

### Solution to Problem

As a result of intensive investigations, the present inventors have discovered that the above-described problems can be solved by the following means and have accomplished the present invention. More specifically, the present invention is as follows:

<Aspect 1> A cover material for blister pack comprising, in order, a substrate layer, a polyolefin-containing layer, and an easy-peel layer,

wherein the easy-peel layer contains an acrylic-modified polyolefin and a maleic acid-modified polyolefin.

<Aspect 2> The cover material according to Aspect 1, wherein the polyolefin is a polyethylene-based resin.
<Aspect 3> The cover material according to Aspect 1 or 2, further comprising a functional layer on a surface of the polyolefin-containing layer on its substrate layer side.
<Aspect 4> The cover material according to Aspect 3, wherein the functional layer is an absorbent layer containing an absorbent layer resin and an absorbent.
<Aspect 5> The cover material according to Aspect 3 or 4, further comprising a skin layer on a surface of the functional layer on its substrate layer side.
<Aspect 6> The cover material according to Aspect 5, wherein the skin layer is an additional polyolefin-containing layer.
<Aspect 7> The cover material according to any one of Aspects 1 to 6, wherein the easy-peel layer contains 40 to 90 mass % of the acrylic-modified polyolefin and 10 to 60 mass % of the maleic acid-modified polyolefin based on the total mass of the easy-peel layer.
<Aspect 8> The cover material according to any one of Aspects 1 to 7, wherein the thickness of the easy-peel layer is from 0.1 to 10 μm.
<Aspect 9> The cover material according to any one of Aspects 1 to 8, wherein, when the easy-peel layer is fused to a blister package comprising at least a polyvinyl chloride layer and having a pocket, thereby forming

a bonded portion in which the polyvinyl chloride layer of the blister package and the easy-peel layer are bonded, and

an unbonded portion which corresponds to the pocket of the blister package and in which the blister package and the easy-peel layer are not bonded, and

then the cover material is peeled off from the polyvinyl chloride layer of the blister package,

(i) the blister package can be interfacially peeled off from the easy-peel layer or
(ii) the easy-peel layer can be cohesively peeled off.
<Aspect 10> A contents-containing blister pack, comprising contents, a blister package, and a cover material,

wherein the blister package comprises at least a polyvinyl chloride layer and has a pocket,

wherein the cover material package, in order, a substrate layer, a polyolefin-containing layer, and an easy-peel layer,

the easy-peel layer contains an acrylic-modified polyolefin and a maleic acid-modified polyolefin,

the easy-peel layer of the cover material is fused to the polyvinyl chloride layer of the blister package, whereby contents are contained within the pocket,

a bonded portion in which the blister package and the easy-peel layer are bonded and

an unbonded portion which corresponds to the pocket of the blister package and in which the blister package and the easy-peel layer are not bonded

are formed, and

when the cover material is peeled off from the blister package,

(i) the blister package can be interfacially peeled off from the easy-peel layer or

(ii) the easy-peel layer can be cohesively peeled off.

<Aspect 11> A combination of a cover material for blister pack and a blister package,

wherein the blister package comprises at least a polyvinyl chloride layer and has a pocket,

wherein the cover material comprises, in order, a substrate layer, a polyolefin-containing layer, and an easy-peel layer,

the easy-peel layer contains an acrylic-modified polyolefin and an acid-modified polyolefin,

when the easy-peel layer of the cover material is fused to the polyvinyl chloride layer of the blister package, thereby forming

a bonded portion in which the blister package and the easy-peel layer are bonded and

an unbonded portion which corresponds to the pocket of the blister package and in which the blister package and the easy-peel layer are not bonded, and

then the cover material is peeled off from the blister package,

(i) the blister package can be interfacially peeled off from the easy-peel layer or

(ii) the easy-peel layer can be cohesively peeled off.

### Advantageous Effects of Invention

According to the present invention, a cover material for blister pack which can be easily opened without breaking the cover material, can be provided.

### BRIEF DESCRIPTION OF DRAWINGS

FIG. 1 is a diagram illustrating a layer structure in one embodiment of the blister pack of the present invention.

FIG. 2 is a diagram illustrating an opening mechanism in one embodiment of the blister pack of the present invention.

FIG. 3 is a diagram illustrating the opening mechanism in preferred embodiment (ii) below of the blister pack of the present invention.

### DESCRIPTION OF EMBODIMENTS

<<Cover Material for Blister Pack>>

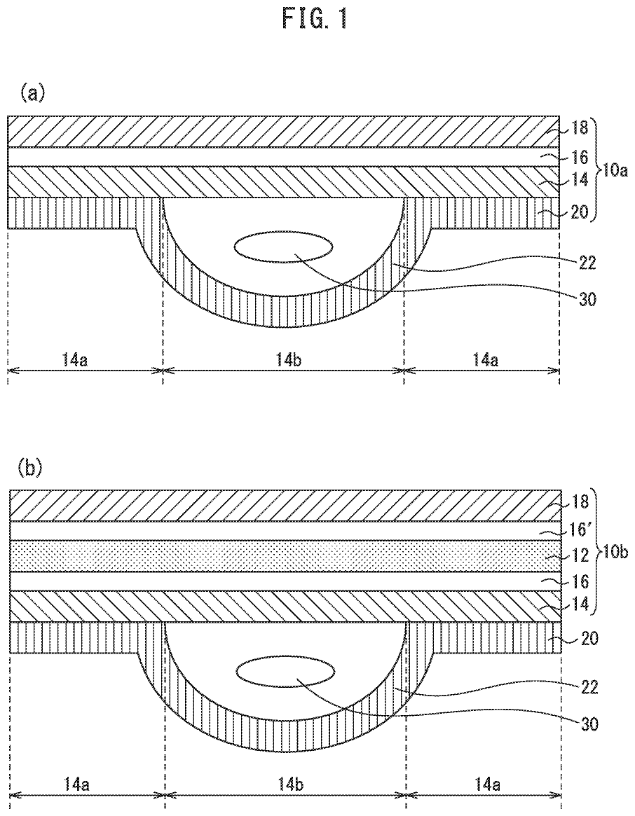

As illustrated in FIG. 1(a), a cover material for blister pack 10a of the present invention comprises, in order

a substrate layer 18, a polyolefin-containing layer 16, and an easy-peel layer 14, and

the easy-peel layer contains an acrylic-modified polyolefin and a maleic acid-modified polyolefin.

In the present specification, the term “easy-peel layer” means a layer in which, after a polyvinyl chloride layer of a blister package comprising at least the polyvinyl chloride layer and having a pocket is bonded to a cover material on its easy-peel layer side, the blister package is interfacially peeled off from the easy-peel layer and/or cohesive failure is caused in the easy-peel layer, whereby a substrate layer and a functional layer can be separated from the blister package to make an opening.

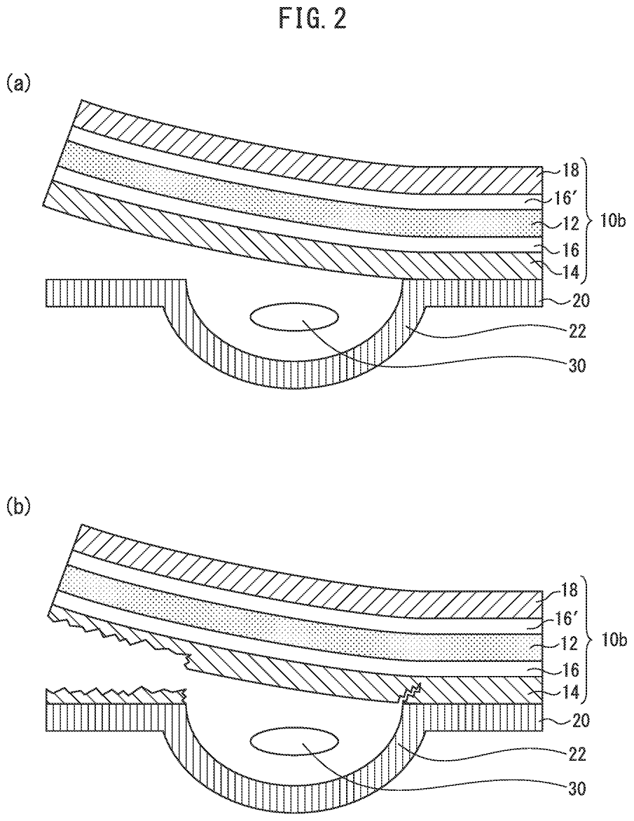

More specifically, the easy-peel layer is an easy-peel layer 14 from which a blister package 20 can be interfacial peeled off as illustrated in FIG. 2(a), and/or an easy-peel layer 14 in which a cohesive failure is caused as illustrated in FIG. 2(b). The easy-peel layer 14 may be a layer that can be broken in correspondence to the pocket 22 of the blister package 20.

The cover material for blister pack of the present invention can be easily opened to take out the contents without breaking the cover material due to the presence of the easy-peel layer when opening due to breakage of the cover material is not preferable, for example, when a blister pack in which a tablet of a soft gel-like substance is sealed as its contents is opened.

In addition, in the cover material for blister pack of the present invention, the easy-peel layer contains an acrylic-modified polyolefin. Since the easy-peel layer contains an acrylic-modified polyolefin, good fusing property to polyvinyl chloride having good formability can be achieved with a thin film thickness, as a result, cost reduction and good production speed can be achieved.

Furthermore, in the cover material for blister pack of the present invention, since the easy-peel layer contains a maleic acid-modified polyolefin, adhesiveness to the polyolefin-containing layer is provided, and as a result, the interlayer strength between the polyolefin-containing layer and the easy-peel layer is increased, and thus, unintentional peeling between these layers can be suppressed.

In a preferred embodiment of the present invention, when the easy-peel layer is fused to a blister package having a pocket, thereby forming

a bonded portion in which the blister package and the easy-peel layer are bonded, and

an unbonded portion which corresponds to the pocket of the blister package and in which the blister package and the easy-peel layer are not bonded, and

then the cover material is peeled off from the blister package,

(i) as mentioned with respect to FIG. 2(a), the blister package can be interfacially peeled off from the easy-peel layer or
(ii) the easy-peel layer can be cohesively peeled off.

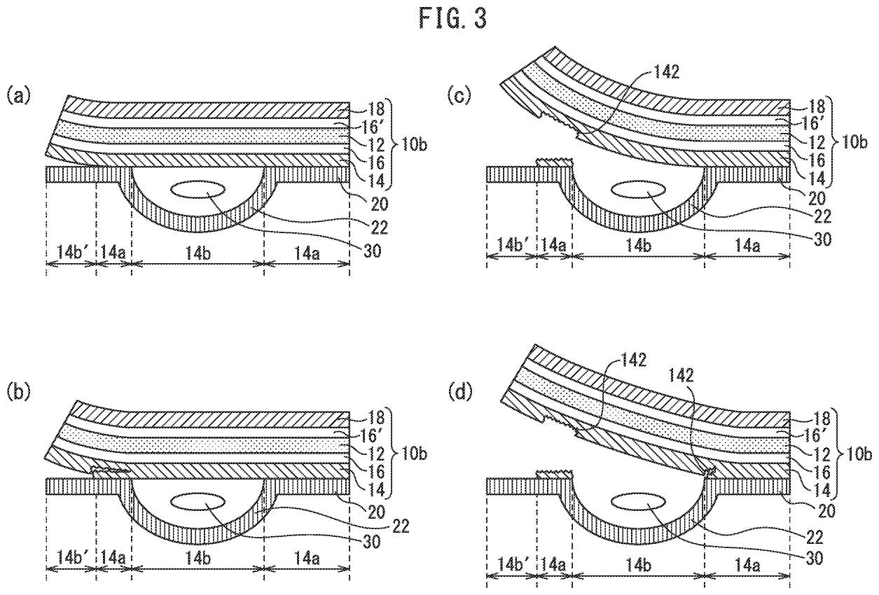

In particular, in the preferred embodiment (ii) above, in the bonded portion, a part of the easy-peel layer can follow the blister package, and in the unbonded portion, the entirety of the easy-peel layer can follow the polyolefin-containing layer. This embodiment is described by referring to FIG. 3.

As illustrated in FIG. 3(a), the blister package 20 having a pocket 22 is bonded to the cover material 10, thereby forming a bonded portion 14a in which the blister package 20 and the easy-peel layer 14 are bonded, and an unbonded portion 14b which corresponds to the pocket 22 of the blister package 20 and in which the blister package 20 and the easy-peel layer 14 are not bonded, and when the cover material 10 is peeled off, the easy-peel layer 14 is cohesively peeled off in a region corresponding to the bonded portion 14a.

In order to realize this cohesive peel off, it is also possible to further provide an unbonded portion 14 b′ between the blister package and the easy-peel layer and use it as a peeling trigger. In the case of this embodiment, when the peeled surface reaches the boundary between the unbonded portion 14b′ and the bond portion 14a, as illustrated in FIG. 3(b), a breaking part 142′ is formed in the easy-peel layer 14, and the easy-peel layer 14 is cohesively peeled off in a region corresponding to the bonded portion 14a such that a part of the easy-peel layer 14 follows the polyolefin-containing layer 16 while another part of the easy-peel layer 14 remains on the blister package 20.

When the easy-peel layer 14 is further cohesively peeled off, the peeled surface eventually reaches the boundary between the bonded portion 14a and the unbonded portion 14b and, as illustrated in FIG. 3(c), a breaking part 142 is formed in the easy-peel layer 14. Then, in the unbonded portion 14b, the easy-peel layer 14 follows the polyolefin-containing layer 16 to thereby open the blister pack.

When the opening is further proceeded, the breaking part 142 reaches the opposite edge of the pocket 22 and, as illustrated in FIG. 3(d), the easy-peel layer 14 is severed in correspondence to the pocket 22.

In another embodiment, as illustrated in FIG. 1(b), the cover material for blister pack 10b of the present invention may further have an optional functional layer 12 on a surface of the polyolefin-containing layer 16 on its substrate layer side. In particular, when the functional layer contains a specific substance, the cover material for blister pack can be opened without bringing this substance into contact with the contents, and thus, the cover material for blister pack according to the present invention is more beneficial.

Further, as illustrated in FIG. 1 (b), the cover material for blister pack 10b of the present invention may further have a skin layer 16′ on a surface of the functional layer 12 on the substrate layer 18 side. This skin layer 16′ may be an additional polyolefin-containing layer.

Each constituent element of the present invention is described below.

<Substrate Layer>

The substrate layer may be composed of only a barrier layer or only a resin layer or may be composed of a barrier layer and a resin layer.

(Barrier Layer)

As the barrier layer, a material capable of suppressing permeation of moisture, an organic gas, and an inorganic gas from the outside into the functional layer can be used. The barrier layer which can be used includes, for example, but is not limited to, a metal foil such as aluminum foil and aluminum alloy, an inorganic vapor-deposited film such as aluminum vapor-deposited film, silica vapor-deposited film, alumina vapor-deposited film or silica-alumina binary vapor-deposited film, and an organic coating film such as polyvinylidene chloride-coated film or polyvinylidene fluoride-coated film. In particular, from the viewpoint of making it easier to achieve both the barrier property and the handling property as the cover material, the barrier layer used is preferably an aluminum foil.

The thickness of the barrier layer is preferably 7 μm or more, 10 μm or more, or 15 μm or more, from the viewpoint of ensuring strength and barrier property, and is preferably 45 μm or less, 40 μm or less, or 35 μm or less, from the viewpoint of improving the handling property as the cover material.

(Resin Layer)

As the resin layer, thermoplastic resins excellent in impact resistance, abrasion resistance, etc., for example, polyolefin, vinyl-based polymer, polyester, and polyamide, can be used individually or as a multilayer combination of two or more kinds thereof. The resin layer may be a stretched film or an unstretched film. The resin layer can be present on one side or both sides of the barrier layer. This resin layer can protect the barrier layer.

The polyolefin includes a polyethylene-based resin, a polypropylene-based resin, etc.

In the present description, the polyethylene-based resin indicates a resin containing more than 50 mol %, more than 60 mol %, more than 70 mol %, or more than 80 mol %, of a repeating unit of ethylene group in the main chain of the polymer and, for example, is selected from the group consisting of low-density polyethylene (LDPE), linear low-density polyethylene (LLDPE), medium-density polyethylene (MDPE), high-density polyethylene (HDPE), ethylene-acrylic acid copolymer (EAA), ethylene-methacrylic acid copolymer (EMAA), ethylene-ethyl acrylate copolymer (EEA), ethylene-methyl acrylate copolymer (EMA), their derivatives, and mixtures thereof.

In the present description, the propylene-based resin indicates a resin containing more than 50 mol %, 60 mol % or more, 70 mol % or more, or 80 mol % or more, of a repeating unit of propylene group in the main chain of the polymer and includes, for example, polypropylene (PP) homopolymer, random polypropylene (random PP), block polypropylene (block PP), chlorinated polypropylene, acid-modified polypropylene, their derivatives, and mixtures thereof.

The vinyl-based polymer includes, for example, polyvinyl chloride (PVC), polyvinylidene chloride (PVDC), polychlorotrifluoroethylene, polytetrafluoroethylene, polyacrylonitrile (PAN), etc.

The polyester includes, for example, polyethylene terephthalate (PET), polybutylene terephthalate, etc.

The polyamide includes, for example, nylon such as nylon (registered trademark) 6 and nylon MXD6.

The thickness of the resin layer is preferably 7 μm or more, 10 μm or more, or 15 μm or more, from the viewpoint of satisfactorily protecting the barrier layer, and is preferably 55 μm or less, 50 μm or less, or 45 μm or less, from the viewpoint of improving the handling property as the cover material.

<Polyolefin-Containing Layer>

The polyolefin-containing layer is a layer containing a polyolefin and present between the substrate layer and the easy-peel layer. In addition, when the cover material for blister pack has a functional layer, the polyolefin-containing layer may be fused to the functional layer. As the polyolefin, for example, a polyolefin mentioned with respect to the resin layer can be used.

In particular, when the cover material for blister pack has a functional layer mentioned below and the functional layer contains a specific substance, the polyolefin-containing layer can prevent this specific substance from falling off and coming into contact with the contents. In addition, in this case, the polyolefin-containing layer may be a layer that does not contain this specific substance. For example, when the functional layer is an absorbent layer containing an absorbent, the polyolefin-containing layer may be a layer containing no absorbent.

In another embodiment, the polyolefin-containing layer may serve as a functional layer. In this case, for example, the polyolefin-containing layer may be a layer containing a polyolefin and an absorbent. In this case, the absorbent may be dispersed in the polyolefin.

The thickness of the polyolefin-containing layer may be 1 μm or more, 3 μm or more, 5 μm or more, or 7 μm or more, and may be 50 μm or less, 40 μm or less, 30 μm or less, 20 μm or less, or 15 μm or less.

<Functional Layer>

The functional layer may be a layer which imparts a specific function to the cover material for blister pack. The functional layer may be a layer based on a thermoplastic resin. Examples of such a functional layer include an absorbent layer, a sustained release layer, and an antibacterial layer.

<Functional Layer: Absorbent Layer>

The absorbent layer is a layer containing an absorbent layer resin and an absorbent. The absorbent may be dispersed in the absorbent layer resin.

The content percentage of the absorbent in the absorbent layer is, based on the mass of the entire absorbent layer, preferably 1 mass % or more, 3 mass % or more, 5 mass % or more, 7 mass % or more, or 10 mass % or more, from the viewpoint of ensuring a good absorption capacity, and is preferably 70 mass % or less, 65 mass % or less, 60 mass % or less, 55 mass % or less, or 50 mass % or less, from the viewpoint of ensuring a good film forming property.

The thickness of the absorbent layer is preferably 1 μm or more, 2 μm or more, 3 μm or more, 5 μm or more, 10 μm or more, 20 μm or more, or 30 μm or more, from the viewpoint of ensuring a good absorption capacity, and is preferably 100 μm or less, 90 μm or less, or 80 μm or less, from the viewpoint of ensuring flexibility of the cover material.

(Absorbent Layer Resin)

As the absorbent layer resin, for example, a thermoplastic resin can be used alone or as a mixture.

The thermoplastic resin includes, for example, polyethylene-based resin, polypropylene-based resin, saturated or unsaturated polyester, ionomer, polyvinyl chloride (PVC), polystyrene, their derivatives, and mixtures thereof.

In the case where the absorbent layer absorbs water vapor, the water vapor permeability in conformity with JIS K 7129 of the resin is, when measured on a film having a thickness of 25 μm at 40° C. and relative humidity of 90%, preferably 5 g/(m²·day) or more, 10 g/(m²·day) or more, or 15 g/(m²·day) or more, from the viewpoint of ensuring a good absorption rate, and is preferably 100 g/(m²·day) or less, 90 g/(m²·day) or less, or 80 g/(m²·day) or less, from the viewpoint of preventing deactivation in the manufacturing process.

In the case where the absorbent layer absorbs oxygen, the oxygen permeability in conformity with JIS K7126-1 of the resin is, when measured on a film having a thickness of 25 μm at 25° C. and a relative humidity of 0%, preferably 5,000 cc/(m²·day·MPa) or more, 10,000 cc/(m²·day·MPa) or more, or 30,000 cc/(m²·day·MPa) or more, from the viewpoint of ensuring a favorable absorption rate, and is preferably 230,000 cc/(m²·day·MPa) or less, 200,000 cc/(m²·day·MPa) or less, or 150,000 cc/(m²·day·MPa) or less, from the viewpoint of preventing deactivation in the manufacturing process.

(Absorbent)

As the absorbent, for example, a moisture absorbent and a gas absorbent can be used.

As the moisture absorbent, a physical moisture absorbent such as hydrophilic zeolite and silica gel, and a chemical moisture absorbent such as calcium oxide, magnesium sulfate, calcium chloride, calcium oxide and aluminum oxide, can be used.

As the hydrophilic zeolite, for example, a zeolite of type A, type X, or type LSX can be used. These may be used individually or in combination.

As the gas absorbent, a physical gas absorbent such as activated carbon and hydrophobic zeolite, an iron-based oxygen absorbent, and a chemical gas absorbent such as metal halide, metal oxide, sulfate, sulfite, bisulfite and dithionite, can be used.

As the hydrophobic zeolite, for example, beta-type, ZSM-5 type, ferrienite-type, mordenite-type, L-type or Y-type zeolite can be used. In addition, ZSM-11, silicalite, silicalite-2, and pentasil-type metallosilicate, which are analogs of ZSM-5 type zeolite, can also be used. These may be used individually or in combination.

As the iron-based oxygen absorbent, iron powder (e.g., reduced iron powder, atomized iron powder, activated iron powder), ferrous oxide, ferrous salt, etc. can be used.

As the metal halide, for example, calcium chloride, sodium chloride, sodium bromide, sodium iodide, potassium chloride, potassium bromide, potassium iodide, calcium chloride, magnesium chloride, barium chloride, etc. can be used.

As the metal oxide, for example, calcium oxide, aluminum oxide, cerium oxide having an oxygen defect, titanium oxide having an oxygen defect, etc. can be used.

<Skin Layer>

The skin layer contains a resin for a skin layer and is a layer present on a surface of the functional layer on its easy-peel layer side. The skin layer may further be present on a surface of the function layer on its substrate layer side. The skin layer may also be fused to the function layer.

In particular, when the functional layer contains a particular substance, the skin layer can prevent this particular substance from falling off and coming into contact with the contents. Also, in this case, the skin layer may be a layer that does not contain this particular substance. For example, when the functional layer is an absorbent layer containing an absorbent, the skin layer may be a layer containing no absorbent.

The skin layer may be additional polyolefin-containing layer containing polyolefin.

The thickness of the skin layer may be 1 μm or more, 3 μm or more, 5 μm or more, or 7 μm or more, and may be 50 μm or less, 40 μm or less, 30 μm or less, 20 μm or less, or 15 μm or less. The thicknesses of the skin layer and that of the polyolefin-containing layer may be the same or different.

(Skin Layer Resin)

As the skin layer resin, the thermoplastic resins recited with respect to the resin layer can be used individually or as a mixture thereof. In the case where the skin layer is present on both sides of the functional layer, the skin layer resins constituting respective skin layers may be the same or different.

<Easy-Peel Layer>

The easy-peel layer is a layer containing an acrylic-modified polyolefin and a maleic acid-modified polyolefin. The easy-peel layer may be present, for example, as a coating. Further, the easy-peel layer and the polyolefin-containing layer may be in direct contact with each other.

The easy-peel layer preferably contains an acrylic-modified polyolefin in an amount of 40 mass % or more, 45 mass % or more, 50 mass % or more, 55 mass % or more, 60 mass % or more, or 65 mass % or more, and 90 mass % or less, 85 mass % or less, 80 mass % or less, or 75 mass % or less, as well as a maleic acid-modified polyolefin in an amount of 10 mass % or more, 15 mass % or more, 20 mass % or more, 25 mass % or more, and 60 mass % or less, 55 mass % or less, 50 mass % or less, 45 mass % or less, 40 mass % or less, or 35 mass % or less based on the total mass of the easy-peel layer. These amounts are preferable from the viewpoint of realizing good adhesion to the polyolefin-containing layer.

The thickness of the easy-peel layer may be 0.1 μm or more, 0.3 μm or more, 0.5 μm or more, 0.7 μm or more, or 1.0 μm or more, and 20.0 μm or less, 10.0 μm or less, 8.0 μm or less, 5.0 μm or less, or 3.0 μm or less in the coating aspect.

The acrylic-modified polyolefin may be, for example, a polyolefin in which an acrylic component is graft-polymerized on a side chain.

The acrylic component may be, for example, (meth)acrylic acid, methyl(meth)acrylate, ethyl(meth)acrylate, propyl(meth)acrylate, butyl(meth)acrylate, isobutyl acrylate, pentyl(meth)acrylate, hexyl(meth)acrylate, 2-ethylhexyl(meth)acrylate, and combinations thereof.

The maleic acid-modified polyolefin may generally be a polyolefin in which maleic acid is graft-polymerized on a side chain.

<<Manufacturing Method of Cover Material for Blister Pack>>

The cover material for blister pack of the present invention can be manufactured by a method including a film-forming step for film-forming a polyolefin-containing layer and optionally a functional layer and a skin layer, a first laminating step for laminating an easy-peel layer on the polyolefin-containing layer, and a second laminating step for laminating a substrate layer on the polyolefin-containing layer, the functional layer or the skin layer. The first lamination step and the second lamination step may be performed in this order or the inverse order, or these may be performed simultaneously.

<Film-Forming Step>

The film-forming step can be performed by kneading the resins constituting the polyolefin-containing layer and optionally the functional layer and the skin layer by means of, for example, a batch-type kneader such as a kneader, a Banbury mixer, or a mixing roll conical mixer, or a continuous kneader such as a twin-screw kneader, and then forming the kneaded resin into a film shape by a co-extrusion method such as a multilayer inflation method or a multilayer T-die method to integrate the polyolefin-containing layer and optionally the functional layer and the skin layer.

<First Lamination Step>

The first lamination step may be performed by laminating the polyolefin-containing layer and the easy-peel layer via an adhesive layer by a dry lamination method or a sand lamination method, or the easy-peel layer may be formed on the polyolefin-containing layer by a coating means such as gravure coating, spray coating, roll coating, die coating, lip coating, or dip coating or by a printing means such as gravure printing, offset printing, flexographic printing, or silk printing.

<Second Lamination Step>

The second lamination step can be performed by laminating, for example, a substrate layer and a polyolefin-containing layer, a functional layer or an additional skin layer via an adhesive layer by a dry lamination method or a sand lamination method.

<<Contents-Containing Blister Pack>>

The contents-containing blister pack has contents, a blister package, and a cover material. The blister package comprises at least a polyvinyl chloride (PVC) layer and has a pocket. As the cover material, the cover material for blister packs described above can be used.

The easy-peel layer of the cover material is fused to the polyvinyl chloride layer of the blister package, thereby accommodating the contents in the pocket and forming

a bonded portion in which the blister package and the easy-peel layer are bonded, and

an unbonded portion which corresponds to the pocket of the blister package and in which the blister package and the easy-peel layer are not bonded, and

when the cover material is peeled off from the blister package,

(i) the blister package can be interfacially peeled off from the easy-peel layer, or

(ii) the easy-peel layer can be cohesively peeled off.

<Contents>

The contents are not limited as long as they can be deteriorated by contact with the outside air, and may include food, cosmetics, hygiene products, medical equipment, medical appliance, electronic components, etc., in addition to medicaments. Furthermore, the medicament includes a cleaning agent, a pesticide, a reagent, etc., in addition to pharmaceutical formulations.

<Blister Package>

As the blister package, a blister package including at least a PVC layer and having a pocket can be used.

The blister package can be manufactured, for example, by forming a pocket for accommodating the contents, in a blister package sheet. The method for forming the pocket includes a flat-plate type air-pressure forming method, a plug assist compressed-air forming method, a drum-type vacuum molding method, a plug forming method, etc. Among these, the plug forming method using a round-tip cylindrical rod (plug material) made of an ultra-high-molecular-weight polyethylene resin having a viscosity average molecular weight of 1,000,000 or more is preferred for forming the pocket.

As the blister package, a blister package sheet composed of a single-layer PVC layer, or a multilayered blister package sheet in which a plurality of layers including at least a PVC layer are stacked, can be used.

The multilayered blister package sheet may have a substrate layer and a PVC layer. In addition, a barrier layer, a reinforcement layer, an absorbent layer, etc. may be arbitrarily provided between the substrate layer and the PVC layer, and, for example, the sheet has, in order, a substrate layer, a barrier layer, a reinforcement layer, an absorbent layer, and a PVC layer. The method for laminating together adjacent layers includes a dry lamination method, a sand lamination method, etc.

The thickness of the blister package sheet may be, for example, 500 μm or less, 400 μm or less, 300 μm or less, 200 μm or less, 150 μm or less, or 100 μm or less, and may be 50 μm or more, 60 μm, or 70 μm or more, from the viewpoint of suitable strength, elasticity, barrier property, etc. as a blister package.

(PVC Layer for Blister Package)

The PVC layer for the blister package is a layer composed of PVC. Through this layer, the blister package can be fused to the cover material for blister pack of the present invention.

The thickness of the PVC layer may be 300 μm or less, 200 μm or less, 150 μm or less, 130 μm or less, or 100 μm or less, and may be 10 μm or more, 20 μm or more, 30 μm or more, 40 μm or 50 μm or more, from the viewpoint of imparting appropriate formability to the blister package sheet.

(Substrate Layer for Blister Package)

The resin used in the substrate layer for the blister package is not particularly limited as long as it imparts an appropriate barrier property and formability to the blister package sheet. Examples thereof include polyethylene-based resin, polyvinyl chloride, polyvinylidene chloride, polypropylene-based resin, saturated polyester, polyamide (e.g., nylon (registered trademark), nylon 6, nylon 6,6, nylon MXD6), cyclic polyolefin (COP, COC), fluorine-based resin (e.g., polychlorotrifluoroethylene, polytetrafluoroethylene), etc., and mixtures thereof. These layers may be used as a single layer or may be used by stacking two or more layers thereof. A resin having excellent moisture resistance and preventing entering of moisture from the outside is preferred, and such a resin includes, in particular, polypropylene-based resin, polyamide, and saturated polyester.

The thickness of the substrate layer may be 10 μm or more, 20 μm or more, or 30 μm or more, and may be 300 μm or less, 200 μm or less, or 100 μm or less, from the viewpoint of maintaining the barrier property and giving strength or the like to the entire blister pack.

(Barrier Layer for Blister Package)

The material used in the barrier layer for the blister package may include a metal foil such as aluminum foil, a silica vapor-deposited film, an aluminum vapor-deposited film, an alumina vapor-deposited film, a silica-alumina vapor-deposited film, a vinylidene chloride-coated film, a polyvinylidene fluoride-coated film, etc., and combinations thereof. The thickness of the barrier layer may be 7 μm or more, 10 μm or more, or 20 μm or more, and may be 60 μm or less, 50 μm or less, or 40 μm or less, from the viewpoint of imparting appropriate formability and barrier property to the blister package sheet.

(Reinforcement Layer for Blister Package)

The reinforcing layer for the blister package is used to improve the formability of the blister package sheet. The resin used in the reinforcement layer includes, for example, high-density polyethylene, polyvinyl chloride, polypropylene-based resin, polyethylene terephthalate, polyamide (e.g., nylon (registered trademark), nylon 6, nylon 6,6, nylon MXD 6), etc., and mixtures thereof. The thickness of the reinforcement layer may be, for example, 10 μm or more, 15 μm or more, or 25 μm or more, and may be 60 μm or less, or 50 μm or less.

(Other Layers)

The multilayered blister package sheet may have other optional layers. Other layers include, for example, a functional layer containing an absorbent in a thermoplastic resin, a skin layer on the functional layer, an adhesive layer for adhering respective layers, and the like. The functional layer of the cover material and the functional layer of the blister package sheet may be the same or different in terms of, for example, layer thickness or type or content of the absorbent or resin.

<Cover Material>

The cover material may be the cover material for blister packs described above.

<<Combination>>

The combination of the present invention is a combination of a cover material for blister packs and a blister package including at least a polyvinyl chloride layer and having a pocket.

In this combination, when the easy-peel layer of the cover material is fused to the polyvinyl chloride layer of the blister package, thereby forming

a bonded portion in which the blister package and the easy-peel layer are bonded, and

an unbonded portion which corresponds to the pocket of the blister package and in which the blister package and the easy-peel layer are not bonded, and

then the cover material is peeled off,

(i) the blister package can be interfacically peeled off from the easy-peel layer, or

(ii) the easy-peel layer can be cohesively peeled off.

As the cover material for blister packs and the blister package, the above-mentioned cover material for blister packs and the blister package can be used, respectively.

### EXAMPLES

The present invention is specifically described by referring to Examples and Comparative Examples, but the present invention is not limited thereto.

<<Production of Cover Material for Blister Packs>>

### Example 1

A two-kind three-layer absorbent film was prepared by air-cooled inflation co-extrusion forming such that a skin layer, an absorbent layer as a functional layer and a skin layer are arranged in this order. As the skin layer, a linear low-density polyethylene was used, and as the resin for the absorbent layer, a resin prepared by melt-kneading a hydrophilic zeolite and an ethylene-methacrylic acid copolymer (EMAA) was used. The thickness of each layer was 10 μm for the skin layer, 30 μm for the absorbent layer, and 10 μm for the skin layer.

Then, the surface wettability of one skin layer of the prepared absorbent film was confirmed, and after applying a corona treatment, if desired, the aluminum foil side of a PET (12 μm)//aluminum foil (9 μm) laminate serving as a substrate layer was laminated on the skin layer side above by using a dry laminate adhesive.

Then, 47.8 mass parts of an acrylic-modified polyolefin and 52.2 mass parts of a maleic acid-modified polyolefin were mixed, and this was applied on the other skin layer side and dried, whereby the easy-peel layer was laminated to prepare a cover material for blister pack of Example 1.

### Examples 2-4, Comparative Example 1, and Reference Example

Cover materials for blister pack of Examples 2 to 4, Comparative Example 1, and Reference Example were prepared in the same manner as in Example 1, except that an easy-peel layer having the configuration shown in Table 1 was used as the easy-peel layer.

### Comparative Example 2

A cover material for blister pack of Comparative Example 2 was prepared in the same manner as in Example 1 except that the easy-peel layer was not laminated.

<<Evaluation>>

<Peel Test>

The easy-peel layer or skin layer side of the prepared cover material for blister packs was heat-sealed to the PVC layer side of a blister package sheet having a layer structure of nylon (25 μm)//aluminum foil (40 μm)//PVC (60 μm). The heat-sealing conditions were a temperature of 150° C. on the cover material for blister packs side, a temperature of 40° C. on the blister package sheet side, a duration of 3 second, and a pressure of 0.2 MPa.

Subsequently, the heat-sealed assembly of the cover material for blister packs and the blister package sheet was cut out to a width of 15 mm, and the easy peelability of the cover material was evaluated, in conformity with JIS K 6854-3, by conducting T-shape peeling under the condition of a tensile speed of 300 mm/min by use of a tensile tester, and measuring the heat seal strength.

<Moisture Absorption Test>

The cover material for blister packs prepared was cut out into 100 mm×100 mm to obtain a sample for moisture absorption test, and the mass of the sample was measured.

The mass of the sample was measured after the sample was exposed to an environment at a temperature of 60° C. and a relative humidity of 100% RH for 6 hours.

The mass difference before and after the treatment was calculated, and the mass value obtained was converted to the mass per 1 m².

The evaluation criteria are as follows:

good: The moisture absorption is 1 g/m² or more.

bad: The moisture absorption is less than 1 g/m².

The results are given in Table 1.

TABLE 1

| | Configuration | | | | | | | |
|---|---|---|---|---|---|---|---|---|
| | | | | Easy-peel layer | | | | |
| | | | | | Content of | | | |
| | | Functional | | Content of | maleic | Evaluation | | |
| | | layer | | acrylic-modified | acid-modified | Peel | | |
| | Substrate | (Absorbent | Skin | polyolefin | polyolefin | strength | Peeling | Moisture |
| | layer | layer) | layer | (mass %) | (mass %) | (N/15 mm) | point | Absorbency |
| Comparative | PET//AL | Hydrophilic | LLDPE | 0.0 | 100.0 | (Not bonded) | (Interface between easy-peel | good |
| Example 1 | | Zeolite + | | | | | layer and skin layer) | |
| Example 1 | | EMAA | | 47.8 | 52.2 | 2.2 | (Cohesive failure in easy-peel | good |
| Example 2 | | | | 68.1 | 31.9 | 3.7 | layer or interface between | good |
| Example 3 | | | | 76.2 | 23.8 | 3.4 | easy-peel layer and blister | good |
| Example 4 | | | | 83.3 | 16.7 | 2.3 | package sheet) | good |
| Reference | | | | 100.0 | 0.0 | 1.5 | (Interface between the | good |
| Example | | | | | | | easy-peel | |
| Comparative | | | | — | — | (Not bonded) | layer and the skin layer) | good |
| Example 2 | | | | | | | | |

From Table 1, it can be understood that the cover materials for blister pack of Examples 1 to 4, in which the easy-peel layer contains an acrylic-modified polyolefin and an acid-modified polyolefin, has good sealing strength compared with the cover materials for blister pack of Reference Example and Comparative Examples 1 and 2, which do not contain at least one of them.

Similarly, from Table 1, it can be understood that the functionality of any of the cover materials for blister pack of Examples 1 to 4 is not impaired.

### REFERENCE SIGNS LIST

10 Cover material for blister packs
12 Functional layer
14 Easy-peel layer
14a Bonded portion
14b, 14b′ Unbonded portion
142, 142′ Breaking part
16 Polyolefin-containing layer
16′ Skin layer
18 Substrate layer
20 Blister package
22 Pocket
30 Contents

1. A cover material for blister pack comprising, in order, a substrate layer, a polyolefin-containing layer, and an easy-peel layer,
wherein the easy-peel layer contains an acrylic-modified polyolefin and a maleic acid-modified polyolefin.

2. The cover material as claimed in claim 1, wherein the polyolefin is a polyethylene-based resin.

3. The cover material as claimed in claim 1, further comprising a functional layer on a surface of the polyolefin-containing layer on its substrate layer side.

4. The cover material as claimed in claim 3, wherein the functional layer is an absorbent layer containing an absorbent layer resin and an absorbent.

5. The cover material as claimed in claim 3, further comprising a skin layer on a surface of the functional layer on its substrate layer side.

6. The cover material as claimed in claim 5, wherein the skin layer is an additional polyolefin-containing layer.

7. The cover material as claimed in claim 1, wherein the easy-peel layer contains 40 to 90 mass % of the acrylic-modified polyolefin and 10 to 60 mass % of the maleic acid-modified polyolefin based on the total mass of the easy-peel layer.

8. The cover material as claimed in claim 1, wherein the thickness of the easy-peel layer is from 0.1 to 10 μm.

9. The cover material as claimed in claim 1, wherein, when the easy-peel layer is fused to a blister package comprising at least a polyvinyl chloride layer and having a pocket, thereby forming
a bonded portion in which the polyvinyl chloride layer of the blister package and the easy-peel layer are bonded, and
an unbonded portion which corresponds to the pocket of the blister package and in which the blister package and the easy-peel layer are not bonded, and
then the cover material is peeled off from the polyvinyl chloride layer of the blister package,
(i) the blister package can be interfacially peeled off from the easy-peel layer or
(ii) the easy-peel layer can be cohesively peeled off.

10. A contents-containing blister pack, comprising contents, a blister package, and a cover material,
wherein the blister package comprises at least a polyvinyl chloride layer and has a pocket,
wherein the cover material package, in order, a substrate layer, a polyolefin-containing layer, and an easy-peel layer,
the easy-peel layer contains an acrylic-modified polyolefin and a maleic acid-modified polyolefin,
the easy-peel layer of the cover material is fused to the polyvinyl chloride layer of the blister package, whereby contents are contained within the pocket,
a bonded portion in which the blister package and the easy-peel layer are bonded and
an unbonded portion which corresponds to the pocket of the blister package and in which the blister package and the easy-peel layer are not bonded
are formed, and
when the cover material is peeled off from the blister package,
(i) the blister package can be interfacially peeled off from the easy-peel layer or
(ii) the easy-peel layer can be cohesively peeled off.

11. A combination of a cover material for blister pack and a blister package,
wherein the blister package comprises at least a polyvinyl chloride layer and has a pocket,
wherein the cover material comprises, in order, a substrate layer, a polyolefin-containing layer, and an easy-peel layer,
the easy-peel layer contains an acrylic-modified polyolefin and an acid-modified polyolefin,
when the easy-peel layer of the cover material is fused to the polyvinyl chloride layer of the blister package, thereby forming
a bonded portion in which the blister package and the easy-peel layer are bonded and
an unbonded portion which corresponds to the pocket of the blister package and in which the blister package and the easy-peel layer are not bonded, and
then the cover material is peeled off from the blister package,
(i) the blister package can be interfacially peeled off from the easy-peel layer or
(ii) the easy-peel layer can be cohesively peeled off.
